(19) United States
(12) Patent Application Publication
(10) Pub. No.: US 2009/0139639 A1
(43) Pub. Date: Jun. 4, 2009

(54) Method of Producing a Sheet

(75) Inventors: Martin Dobler, Dusseldorf (DE); Roland Kunzel, Leverkusen (DE); Dirk Pophusen, Bergisch-Gladbach (DE); Winfried Kohl, Garden View (ZA); Matthias Boll, Koln (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/367,135

(22) Filed: Feb. 6, 2009

Related U.S. Application Data
(62) Division of application No. 11/397,879, filed on Apr. 3, 2006.

(30) Foreign Application Priority Data
Apr. 6, 2005 (DE) 102005015926.5

(51) Int. Cl. H01B 7/02

(52) U.S. Cl. 156/232

(57) ABSTRACT

A method of producing a plastic sheet equipped with electrical conductors is disclosed. The method that enables automatic production includes (a) fixing in a frame an electrically conducting wire in a sinusoidal, square wave pattern and in a single plane, (b) bringing into contact the single plane and a surface of a plastic sheet under conditions calculated to bond the plastic to said conductor, and (c) removing the frame.

### CROSS-REFERENCE TO RELATED APPLICATIONS

This application claims domestic priority under 35 U.S.C. § 120 and is a divisional application of U.S. patent application Ser. No. 11/397,879, filed Apr. 3, 2006.

### BACKGROUND OF THE INVENTION

In order to reduce body weight in automotive construction, panes of glass are replaced by panes of transparent plastics, for example. The plastics panes used for rear windows are provided as a rule with heating wires.

Vehicle lights, such as for example headlights, rear lights and other illumination means for motor vehicles do not generally require any special de-icing device or demisting device provided that conventional halogen lamps or gas discharge lamps are used. These produce sufficient amounts of heat to thaw ice and snow and remove any misting caused by condensation. In contrast, vehicle lights with cold illumination means such as light-emitting diodes (LEDs) or indeed lights using xenon lamps do not generate sufficient heat and therefore exhibit inadequate thawing capacity. Ice or mist formation on the lenses of vehicle lights is troublesome, and not only for aesthetic reasons: for safety reasons, the light beam should not be dimmed or diffused as it emerges from the light.

It is known to produce plastics panes into which electrical conductors are embedded. Thus, a method is known from DE 101 47 537 in which electrical conductors are associated with a surface of a plastics sheet which is then provided with a further plastics layer by back injection or back injection-compression, in order to form a pane body. Known methods to lay the wires include a laying head is guided over the sheet surface, which continuously presses or incorporates the wires into the surface of the sheet with slight pressure and with application of heat. The disadvantage of this method is that it is comparatively time-consuming, since the wires are pressed continuously into the sheet by means of the laying head.

JP 2003197013 A, JP 2002150812 A and JP 2002211309 A describe the installation of heating wires in the lenses of vehicle lights. Conventional heating wires are clearly visible, however, and unacceptable for aesthetic reasons.

JP 10312705 A describes the installation of sheets or panels in vehicle lights by back injection of the sheet. The sheets or panels are provided with conductive pastes.

An object of the present invention is to provide a method of producing a plastic sheet equipped with a plurality of wires. The method is intended to be as simple as possible and performable in a small number of steps.

### SUMMARY OF THE INVENTION

The invention relates to plastic sheets and in particular to a method for producing sheets equipped with electrical conductors

A method of producing a plastic sheet equipped with electrical conductors is disclosed. The method that enables automatic production includes (a) mounting one or several electrically conducting wire(s) on a frame. (b) bringing into contact the mounted wire(s) and a surface of a plastic sheet under conditions calculated to bond the plastic to said conductor, and (c) removing the frame.

### DETAILED DESCRIPTION OF THE INVENTION

The invention provides a method of producing a plastic sheet equipped with electrical conductors, comprising
(a) mounting one or several electrically conducting wire(s) on a frame.
(b) bringing into contact the mounted wires and a surface of a plastic sheet under conditions calculated to bond the plastic to said conductor, and
(c) removing the frame.

The electrical material suitable as conductor is preferably a metal, particularly preferably tungsten. The diameter of the electrical conductor is preferably 5 μm to 3 mm, particularly preferably 10 to 40 μm. Wires are suitable as electrical conductors.

The wire(s) may be in a straight line or a curved line for example sinusoidal or square wave pattern. The mounted wires may define one or several plane(s).

According to step (a) of the preferred method according to the invention, the term sinusoidal square wave refers to a pattern where the repeating segments (each wave is referred to herein as “segment”) are of short wave-length and high amplitude, and where the two long portions of each segment are preferably parallel one to the other. The conductive wire(s) may for example be affixed in the frame by winding. The wire(s) are mounted in a parallel way or nearly parallel way or in case of curved wires also in a different way for example sinusoidal pattern in a way where amplitudes are facing to each other.

It is also possible for a plurality of frames all to be provided simultaneously with electrical conductors by a process in which, for example, two frames are placed on top of each other and electrical conductors are then wound around both frames. The conductor ends are then fixed in a suitable manner to the frame, e.g. by means of clamping strips. Then the two frames are separated from each other by cutting through the electrical conductors in the region between the two frames. Using such a method two frames with conductors are produced simultaneously and can then be applied to a sheet.

The electrical conductors are preferably arranged in a suitable tool (e.g. a frame) in a single plane, for example by clamping and are spaced apart by 200 μm to 20 cm, preferably by 0.5 mm to 5 cm and particularly preferably by 1 to 10 mm.

A preferred frame is e.g. a rectangular frame, which has combs or series of grooves on at least two opposite sites, which define the position on the conductors of the frame.

In a second step (b) the single plane referred to above is brought into contact with the surface of the plastics sheet in a manner and under condition to bring about their permanent bonding. Application to the plastics sheet may be performed by heating the conductor and/or the plastics sheet. The plastics sheet may be heated in a localized manner or over a large area. In addition or as an alternative, all or some portions of the electrical conductor may be heated. One preferred way of fixing the electrical conductor to the plastics sheet by heating is to heat the electrical conductor over its entire length by application of an electrical voltage, such that the surface of the plastics sheet in contact with the conductor starts to melt, so allowing bonding of the conductor to the plastics sheet. Alternatively, the electrical conductor may also be heated only at points, for example using a hot wire or a soldering iron.

Alternatively or in addition, application of the electrical conductor to the plastics sheet may also be effected by adhesion or welding. Adhesion may be effected either by application of a suitable adhesive or preferably using a solvent which partly dissolves the surface of the sheet, thereby causing adhesion of the electrical conductor to the plastics sheet. In the case where the plastics sheet is of polycarbonate, the use of dioxalane and methylene chloride as solvent for fixing the electrical conductor is preferred.

The application of electrical conductor to a plastics sheet may also be effected under pressure, such that the mounted conductor may be pressed onto the plastics sheet. Pressing preferably takes place at an elevated temperature, which is sufficient for the plastics sheet to start to melt.

In a preferred embodiment of the method, at least one further plastics sheet is applied after application of the conductor onto a plastics sheet according to step (b). This may take place either directly after step (b) or after removal of the frame in step (c). A further plastics sheet is applied in such a way that the electrical conductor is arranged between the first sheet and the second, further sheet. Further plastics sheets may also be applied.

According to a further preferred embodiment, in an additional step (d) a thermoplastic material is applied by injection molding to the plastics sheet now equipped with electrical conductors. Application by injection molding may be effected by film insert molding or film insert compression molding. For simplicity's sake, the term film insert molding is sometimes used below, but for the purposes of the present invention the alternative method of film insert compression molding is always included in the film insert molding.

Alternatively, the plastics sheet provided with electrical conductors may also be applied to a panel, e.g. of thermoplastic material, in particular as is also used for the plastics sheet, or glass. This may be effected for example by means of adhesion or lamination.

The thermoplastic material is preferably applied by film insert molding or film insert compression molding in a thickness of 0.5 mm to 50 mm, particularly preferably 2 mm to 6 mm.

In the case of the injection molding according to step (d), the sheet equipped with electrical conductors produced is preferably positioned in a mold and is reinforced with the injection molded material using an injection molding or injection-compression molding process.

The sheet may optionally be positioned in the moving mold half (ejector half) or in the stationary (fixed) mold half. Depending on the position of the sheet, the latter then lies either inside (overmolding by the injection or injection-compression method) or on the outside of the molding (film insert molding or film insert compression molding).

In the case of the injection molding process (reinforcement process) according to step (d), the sheet preferably has to be immobilized in the mold. Immobilization of the sheet may be achieved for example by means of the geometry of the sheet, by means of electrostatic immobilization, by means of a vacuum, by means of retaining lugs on the sheet or indeed by means of fastening elements in the mold. The sheet is preferably immobilized by means of its geometry.

Precisely positioned immobilization of the sheet is very important in the film insert molding or film insert compression molding process. This is particularly important since special structures in the form of ejectors, slides or core pullers are necessary for precisely positioned bedding in of the electrical conductors for subsequent contacting of the electrical conductors. Bedding in of the conductors is preferably performed using precisely adjustable cores.

After positioning and immobilization of the sheet, injection molding is performed using the film insert molding or film insert compression molding process.

The plastics sheet and the thermoplastic material to be back injected may be of the same or different materials, preferably of the same materials. Transparent or translucent thermoplastics may be used. Examples of suitable thermoplastics are (co)polycarbonates, (co)poly(meth)acrylates, preferably polymethyl methacrylate, (co)polystyrene such as transparent polystyrene or polystyrene acrylonitrile (SAN), thermoplastic polyurethanes, and polyolefins, preferably transparent polypropylene, or polyolefins based on cyclic olefins (e.g. TOPAS®, a product of Ticona), polycondensation products of terephthalic acid, preferably (co)polyethylene terepbthalate (PET or CoPET) or glycol-modified PET (PETG).

Materials which are particularly preferred are bisphenol-A based polycarbonate, copolycarbonates of bisphenol-A and 1,1 -bis-(4-hydroxyphenyl)-3,3,5-trimethylcyclohexane, and (co)polymethyl methacrylates.

Production of the thermoplastic sheets is known. Depending on subsequent application, sheets may be produced having a thickness of 0.01 to 10 mm, preferably 0.1 to 0.4 mm, and used in the method according to the invention. To achieve a high level of transparency, it is advantageous for the side remote from the direction of introduction of the melt during the back injection process to exhibit as smooth a surface as possible.

In the case of the method according to the invention, the sheet may be provided with an imprint, e.g. of a conductive paste such as Electrodag® 418 SS made by Acheson prior to application of the electrical conductors, e.g. for decorative purposes and/or to effect contacting with an electrical common bus.

The advantage of the inventive method over corresponding conventional application of conductors is that it better enables automated production of sheets equipped with electrical conductors.

The invention further provides a sheet produced using the method according to the invention.

The sheet produced using the method according to the invention may be used for example in visors for motorcycle helmets, or heatable windows, such as rear windows in motor vehicles, or refrigerator doors. To this end, the sheet is preferably processed by film insert molding with a transparent or translucent thermoplastic material. The conductors are connected to a switchable electrical power supply.

The invention further provides lamps, in particular for vehicles, comprising a lens for covering a light outlet opening, wherein the lens comprises a sheet produced using the method according to the invention.

Suitable lights are all known lights, in particular vehicle lights. Preferably the lights have at least one light emitting diode as radiation source. However, lights with conventional radiation sources such as halogen lamps or gas discharge lamps are also suitable.

The sheet provided with electrical conductors preferably has a transparent thermoplastic material applied to it by film insert molding and thus forms a molding comprising a transparent sheet, electrical conductors and a layer of a transparent thermoplastic material. The molding serves as a lens for the light according to the invention. The plastics sheet provided with conductors may be processed by film insert molding in such a way that the sheet provided with electrical conductors forms either on the outside or the inside of the molding, i.e. the lens. Alternatively, the plastics sheet provided with electrical conductors may also be applied to a lens of glass, e.g. by means of adhesion or lamination.

The surface of the molding, i.e. the lens, may be textured or untextured. The molding may also be provided in parts with an imprint, e.g. for decorative purposes. The imprint may also be built up from a number of layers. The molding may be coated or uncoated. Commercially available scratch-resistant coatings, e.g. based on siloxane, polyurethane or acrylate, may be considered as coatings.

The electrical conductors serving as heating means are appropriately linked to suitable sensors and suitable control electronics, in order to automatically control the power consumption of the heating means and match it to the particular load status of the vehicle electrical system.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

### EXAMPLE

To produce a group of parallel wires a rectangular frame is used which has one parallel-movable side piece.

The frame consists of three fixed side elements and a fourth side piece which is movable parallel to the opposite fixed side element. The movable side piece is kept in position by two rails on the right- and lefthand sides. Two arresting blocks on either side of the frame fix the position of the movable side piece. Along the top of the movable side piece and of the opposing fixed side element circular pins are arranged at a distance of one millimeter from each other to form two opposing combs. These pins each have a diameter of one millimeter. A polycarbonate sheet lies directly against the pins and is clamped in the frame. A tungsten wire with a diameter of 19 μm, whose end has been fastened to the fixed side element by adhesive strips is passed over the frame. The wire is wound around one pin, passed over the polycarbonate sheet and wound around the corresponding opposing pin on the movable side piece and passed back to the fixed side element, where it is passed around the next pin. By continuing to “weave” the wire in this manner a pattern is formed on the underlying polycarbonate sheet which consists of a total of 80 parallel wires arranged at a distance of 1 mm from each other. The end of the wire is then in turn fastened tightly to one side element by means of adhesive strips.

In order to fix the wire on the sheet a solvent suitable for the polycarbonate employed is used or alternatively the sheet is heated in localized positions by means of a preferably electrically heated needle, whereby the substrate is softened in localized positions and the wire is connected to the substrate by being pressed into the latter, followed by cooling.

The liquid used for the polycarbonate sheet is a saturated solution of polyearbonate in methylene chloride. It is applied dropwise by means of a pipette to the fixation points, it being necessary to ensure that the wire rests on the polyearbonate sheet or is at least enveloped by the solvent droplet. The solvent evaporates and the droplet hardens to form solid polycarbonate, as a result of which the wire is fixed to the sheet.

After the fixation of the wire to the polycarbonate sheet the frame is loosened and the loops of wire formed are pulled off the pins. The loop ends of the wires are electrically connected to current distribution rails on either side of the assemnbly by means of a silver conducting paste. This ensures that the parallel wires on the sheet can be electrically parallel-connected and can be connected to the two poles of a voltage supply and used as parallel heating wires.

In another embodiment only the free ends of the fixed wire are electrically connected to a voltage supply in order to obtain series-connected parallel wires.

Fixation of the wire as described above at the edge of the polycarbonate sheet is a requirement, although immobilization in the middle, in the form of intermediate fixation, is also recommendable, since this facilitates the further processing of the sheet/wire assembly. The individual fixation points are for example no longer visible after the sheet has been back-injected with a thermoplastic material (also a polycarbonate) or after the wire side of the sheet has been laminated with a second polycarbonate sheet.

What is claimed is:

1. A method of producing a plastic sheet equipped with electrical conductors, comprising
(a) mounting one or several electrically conducting wire(s) on a frame
(b) bringing into contact the mounted wire(s) and a surface of a plastic sheet under conditions calculated to permanently bond the plastic to said conductor, and
(c) removing the frame.

2. The method according to claim 1, further comprising bonding at least one further plastics sheet to said surface.

3. The method according to claim 1, wherein a further thermoplastic material is applied by film insert injection molding or film insert compression molding.

4. The method according to claim 1 wherein said wire consists of a metal, preferably tungsten.

5. The method according to claim 1 wherein the electrical conductor has a thickness of 5 μm to 3 mm.

6. The method according to claim 1 wherein the plastics sheet is a transparent member selected from the group consisting of (co)polycarbonate, (co)polyacrylate, (co)poly(meth)acrylate, (co)polystyrene, thermoplastic polyurethane, polyolefin, and (co)polycondensation products of terephthalic acid.

7. The method according to claim 1 wherein the plastic sheet has thickness of 0.01 to 10 mm.

8. The method according to claim 3 wherein the further plastic is polycarbonate.

9. The method according to claim 3 wherein the part produced has a thickness of 0.5 to 50 mm.

10. The method according to claim 2 wherein a further thermoplastic material is applied by film insert injection molding or film insert compression molding.
